(19) United States
(12) Patent Application Publication
(10) Pub. No.: US 2020/0379410 A1
(43) Pub. Date: Dec. 3, 2020

(54) WATCH AND WATCH FACE THEREOF

(71) Applicant: KABUSHIKI KAISHA PRODIA, Kiryuu-shi, Gunma (JP)

(72) Inventor: Yoshiyasu KOJIMA, Kiryuu-shi, Gunma (JP)

(73) Assignee: KABUSHIKI KAISHA PRODIA, Kiryuu-shi, Gunma (JP)

(21) Appl. No.: 16/301,712

(22) PCT Filed: Jun. 8, 2018
(86) PCT No.: PCT/JP2018/022039

§ 371 Date: Nov. 14, 2018

(30) Foreign Application Priority Data
Jun. 20, 2017 (JP) 2017-120657

(51) Int. Cl. G04B 45/00; G04B 19/04; G04B 19/14

(52) U.S. Cl. CPC G04B 45/0092; G04B 19/14; G04B 19/044

(57) ABSTRACT

A watch includes a watch body, a watch face attached to the watch body and having an opening, and a pointer. The pointer includes an extension portion disposed to sandwich the watch face between the extension portion and the watch body and extending from the opening to face an upper surface of the watch face, and a support portion protruding from the watch body into the upper surface of the watch face via the opening, and connected directly to the extension portion. The pointer includes a change portion formed in the extension portion to change a posture of the extension portion such that a front end of the extension portion is raised with respect to a base end of the extension portion to be apart from the watch face. The watch face is removed from the watch body along the extension portion raised by the change portion.

### TECHNICAL FIELD

The present invention relates to a watch and a watch face, more specifically to a watch including a watch body to which a watch face and pointers are attached.

### BACKGROUND ART

A watch including a watch body to which a watch face and pointers are attached has been used from conventional. In general, the watch face of the watch is disposed between the pointers and the watch body. Accordingly, when the watch face is removed from the watch body, the pointers need to be removed together, and therefore it is troublesome to change the watch face.

As a technique to make it easy to replace the watch face, a watch device having a watch face capable of being replaced depending on people's taste to provide a variety of visual expressions has been proposed as in Patent Literature 1. In this watch device having the watch face capable of being replaced, a cut portion is formed in one side of the watch face, and a fitting plate is fitted in the concave portion. When the watch face is inserted into a storage space from the opening of a casing, the fitting plate is fitted in the concave portion, and therefore it is possible to make it easy to replace the watch face.

### CITATION LIST

### Patent Literature

PTL1: Japanese Utility Model Registration No. 3065535

### SUMMARY OF INVENTION

### Technical Problem

However, the watch device having the watch face capable of being replaced disclosed in PTL 1 has a problem with the concave portion formed in the watch face which may impair the function of the watch face, for example, the legibility of the time and the design.

The present invention has been achieved to solve the above-described problem. It is therefore an object of the present invention to provide a watch having a watch face capable of being easily removed while maintaining the function of the watch face.

### Solution to Problem

According to an aspect of the invention, a watch includes a watch body, a watch face attached to the watch body and having an opening, and a pointer. The pointer includes an extension portion disposed to sandwich the watch face between the extension portion and the watch body and extending from the opening to face an upper surface of the watch face, and a support portion protruding from the watch body into the upper surface of the watch face via the opening, and connected directly to the extension portion. The pointer includes a change portion formed in the extension portion to change a posture of the extension portion such that a front end of the extension portion is raised with respect to a base end of the extension portion to be apart from the watch face. The watch face is removed from the watch body along the extension portion raised by the change portion.

The change portion may include a turning member to turn the extension portion to be raised.

The change portion may change the posture of the extension portion to be orthogonal to the watch face.

The watch may include a plurality of pointers each including the extension portion having the change portion.

The change portion may change postures of extension portions of the plurality of pointers around the opening at different positions.

The watch face may include a fixing portion to fix the watch face to the watch body.

The watch body may include an ejector configured to lift the watch face to separate the watch face from the watch body.

The watch face may be attached to the above-described watch.

According to the present invention, the pointer includes the change portion to change the posture of the extension portion to be raised, and the watch face is removed from the watch body along the extension portion raised by the change part. By this means, it is possible to provide a watch having a watch face capable of being easily removed while maintaining the function of the watch face.

### BRIEF DESCRIPTION OF DRAWINGS

FIG. 1 illustrates the configuration of a watch according to Embodiment 1 of the present invention;

FIG. 2 is a cross-sectional view illustrating the configuration of pointers;

FIG. 3 illustrates a state where an extension portion is turned by a turning member;

FIG. 4 illustrates a state where a watch face is replaced;

FIG. 5 illustrates the configuration of a watch face according to Embodiment 2;

FIG. 6 illustrates a state where the watch face is removed from the watch body according to Embodiment 3;

FIG. 7 illustrates the configuration of the turning member according to Embodiment 4;

FIG. 8 illustrates the configuration of the watch body according to Embodiment 5; and

FIG. 9 illustrates the configuration of the change portion according to a modification of Embodiments 1 to 5.

### DESCRIPTION OF EMBODIMENTS

Hereinafter, the embodiments of the present invention will be described with reference to the drawings.

### Embodiment 1

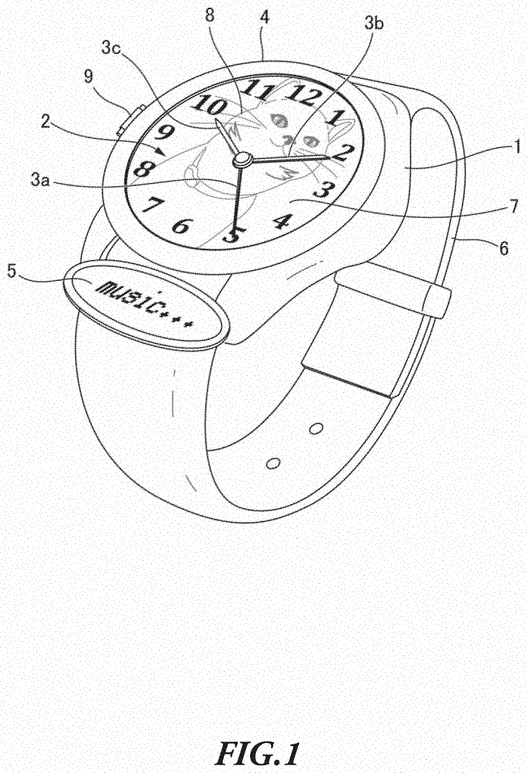

FIG. 1 illustrates the configuration of a watch according to Embodiment 1 of the present invention. This watch is a wristwatch worn on a wrist, and includes a watch body 1. A watch face 2, three pointers 3a to 3c, a protection member 4, a display 5, and a belt 6 are attached to the watch body 1.

The watch body 1 is configured to support each part such as the watch face 2, and has a shape extending along the wrist. The watch body 1 may be made of a material with a high rigidity, for example, metal. In addition, the watch body 1 includes an information input unit (not shown) used to input, for example, music information and output music by wireless. The watch face 2 has a discoid shape and is attached to the watch body 1. A decoration 8 is displayed on an upper surface 7 of the watch face 2 together with the time.

The pointers 3a to 3c indicate the time displayed on the upper surface 7 of the watch face 2, and are provided to rotate in the plane parallel to the watch face 2. The pointer 3a is a second hand indicating the second on the watch face 2. The pointer 3b is a minute hand indicating the minute on the watch face 2. The pointer 3c is an hour hand indicating the hour on the watch face 2. The protection member 4 is configured to protect the watch face 2, and provided to cover the watch face 2. An open and close member 9 is provided on the edge of the protection member 4. This open and close member 9 opens and closes the protection member 4 so as to rotate the protection member 4.

The display 5 is configured to display information to the outside, which may be a liquid crystal monitor. The display 5 may be connected to, for example, the information input unit of the watch body 1, and display music information such as the title of a song inputted to the information input unit. The belt 6 is attached to a pair of opposite edges of the watch body 1 and worn around the wrist to fix the watch body 1 to the wrist.

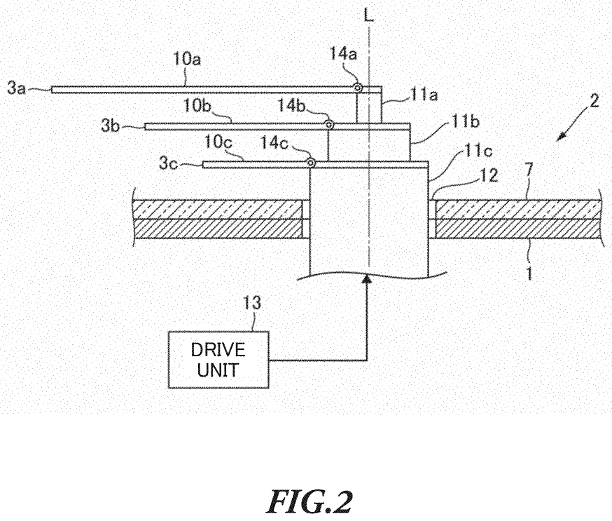

Next, the configuration of the pointers 3a to 3c will be described. As illustrated in FIG. 2, the pointers 3a to 3c include extension portions 10a to 10c, and support portions 11a to 11c, respectively. The extension portions 10a to 10c are provided to sandwich the watch face 2 between the extension portions 10a to 10c and the watch body 1. Here, an opening 12 is formed near the center of the watch face 2. The extension portions 10a to 10c extend from the opening 12 toward the edge of the watch face 2 parallel to the upper surface 7 of the watch face 2. In this case, the extension portions 10a to 10c are disposed at different positions apart from each other in a direction orthogonal to the watch face 2, and are spaced from the watch face 2 in order of the extension portions 10a, 10b, and 10c.

The support portions 11a to 11c are provided to protrude from the watch body 1 into the upper surface 7 of the watch face 2 via the opening 12, and front ends of the support portions 11a to 11c are connected to the extension portions 10a to 10c, respectively. To be more specific, the support portion 11a at the top is connected to the extension portion 10a; the support portion 11b protruding between the support portion 11a and the support portion 11c is connected to the extension portion 10b; and the support portion 11c at the bottom is connected to the extension portion 10c. These support portions 11a to 11c are attached to the watch body 1 to rotate about a rotation center L as an axis extending orthogonal to the watch face 2. The support portions 11a to 11c are rotated by a drive unit 13 provided in the watch body 1 according to the progression of time.

The pointers 3a to 3c include turning members 14a to 14c configured to turn the extension portions 10a to 10c to be raised to change the postures of the extension portions 10a to 10c, respectively. These turning members 14a to 14c are disposed near the base ends of the extension portions 10a to 10c.

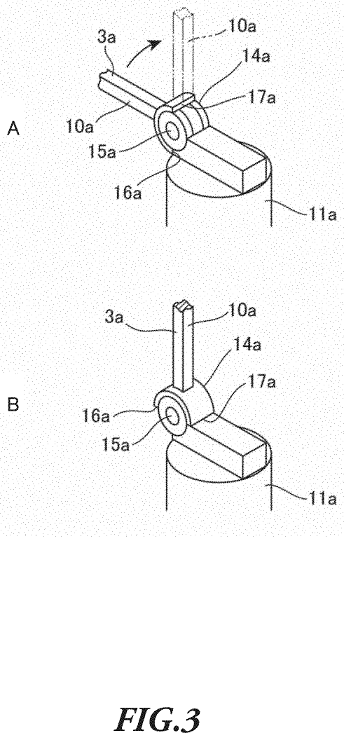

As illustrated in FIG. 3A, the turning member 14a is disposed near the base end of the extension portion 10a to turn the extension portion 10a to be raised from the upper surface 7 of the watch face 2. The turning member 14a includes a turning shaft 15a, an end portion 16a, and an end portion 17a. The turning shaft 15a serves as the axis of turning of the extension portion 10a and extends in a direction orthogonal to the extension portion 10a.

The end portion 16a contacts the extension portion 10a in the vicinity of the base end of the extension portion 10a in order to maintain the posture of the extension portion 10a extending parallel to the watch face 2. The end portion 16a is formed on the lower surface side of the extension portion 10a. Meanwhile, as illustrated in FIG. 3B, when the extension portions 10a is tuned 90 degrees, the end portion 17a abuts on the extension portion 10a in the vicinity of the base end of the extension portion 10a to maintain the posture of the extension portion 10a. The end portion 17a is formed on the upper surface side of the extension portion 10a. As described above, the extension portion 10a is turned about the turning shaft 15a in a direction approximately orthogonal to the watch face 2 to maintain the posture of the extension portion 10a by the end portion 17a. Here, the configuration of the turning members 14b and 14c is approximately the same as that of the turning member 14a.

Here, as illustrated in FIG. 2, the turning members 14a to 14c are located inside the opening 12 in a direction along the watch face 2. Therefore, when the extension portions 10a to 10c are raised by the turning members 14a to 14c and therefore are orthogonal to the upper surface 7 of the watch face 2, the extension portions 10a to 10c are located within the opening 12 in the direction along the watch face 2. That is, the extension portions 10a to 10c are raised to extend in the opening direction of the opening 12. Then, the opening 12 is moved along the extension portions 10a to 10c raised by the turning members 14a to 14c, so that the watch face 2 is removed from the watch body 1.

Next, the operation according to Embodiment 1 will be described. First, as illustrated in FIG. 1, the watch face 2 on which the decoration 8 is displayed is attached to the watch body 1. In this case, as illustrated in FIG. 2, the pointers 3a to 3c are rotated on the upper surface 7 of the watch face 2 by the drive unit 13 to indicate the time displayed on the watch face 2.

Next, the drive unit 13 is stopped by pushing, for example, a stop switch (not shown) to stop the rotation of the pointers 3a to 3c. Then, the protection member 4 covering the pointers 3a to 3c is pushed up by the hand to separate the protection member 4 from the watch body 1, and opened by the rotation of the open and close member 9 to a position where the protection member 4 does not overlap the watch face 2.

When the protection member 4 is opened, the front ends of the pointers 3a to 3c are pushed up by the hand such that the pointers 3a to 3c are apart from the watch face 2. Then, the extension portions 10a to 10c of the pointers 3a to 3c are turned by the turning members 14a to 14c to change the postures of the extension portions 10a to 10c such that the extension portions 10a to 10c are approximately orthogonal to the upper surface 7 of the watch face 2, as illustrated in FIGS. 3A and 3B. In this case, the end portions 17a to 17c of the turning members 14a to 14c abut on the extension portions 10a to 10c in the vicinity of the base ends of the extension portions 10a to 10c, and therefore it is possible to easily raise the extension portions 10a to 10c such that the extension portions 10a to 10c are approximately orthogonal to the watch face 2. In addition, the configuration of the turning members 14a to 14c is simple where the turning members 14a to 14c turn about the turning shafts 15a to 15c, and therefore it possible to easily provide the turning member 14a to 14c for the extension portions 10a to 10c.

Here, as illustrated in FIG. 2, the turning members 14a to 14c are disposed in different positions in a direction along the watch face 2. To be more specific, the farther the turning members 14a to 14c are located from the watch face 2 in a direction orthogonal to the watch face 2, the closer the turning members 14a 14c are disposed to the rotation center L of the pointers 3a to 3c. By this means, the turning positions of the extension portions 10a to 10c are different in the direction along the watch face 2. Therefore, even though the extension portions 10a to 10c are turned to overlap with each other in the direction orthogonal to the watch face 2, it is possible to raise the extension portions 10a to 10c without touching each other.

Moreover, the extension portions 10a to 10c are moved to overlap with each other, and therefore it is possible to turn the extension portions 10a to 10c by the turning members 14a to 14c at a time. For example, an alignment switch is connected to the drive unit 13 and pushed to automatically rotate the pointers 3a to 3c to point the same position in the watch face 2, so that the extension portions 10a to 10c can be moved to overlap with each other. In this case, it is preferred that a raising member is stored in the watch body 1 to collectively raise the extension portions 10a to 10c which have been moved to overlap with each other. This raising member is stored in the edge of the watch face 2 to easily take the raising member out of the edge. Therefore, it is possible to easily raise the extension portions 10a to 10c. For example, the raising member may be formed in a hook shape, so that it is possible to pull up the extension portions 10a to 10c from below.

Here, it is preferred that the turning members 14a to 14c are spaced from each other at a distance which is approximately the same as the thickness of each of the extension portions 10a to 10c in the direction along the watch face 2. By this means, the turning members 14a to 14c are close to each other in the direction along the watch face 2, and therefore it is possible to reduce the size of the opening 12 of the watch face 2 depending on the arrangement of the turning members 14a to 14c.

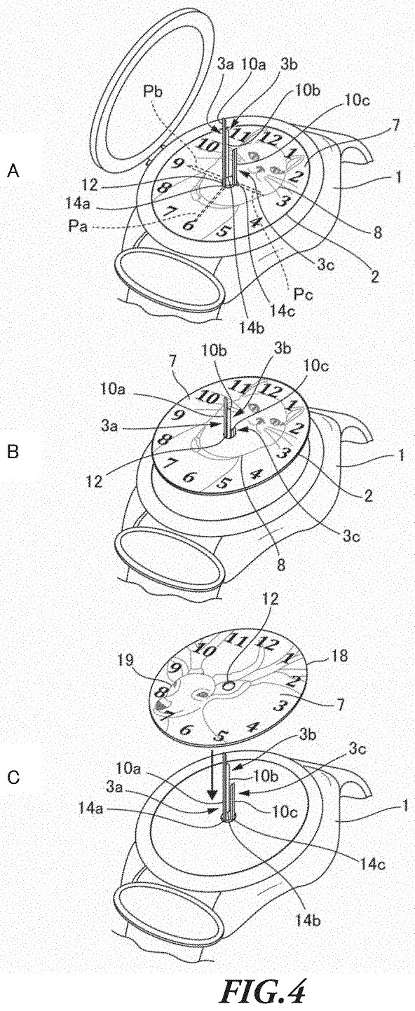

Moreover, it is preferred the turning members 14a to 14c turn the extension portions 10a to 10c around the opening 12 of the watch face 2 at different positions to change the postures of the pointers 3a to 3c. For example, as illustrated in FIG. 4A, the extension portions 10a to 10c are rotated around the opening 12 of the watch face 2 to move to positions Pa to Pc with an angle of 90 degrees from each other, and then the turning members 14a to 14c may turn the extension portions 10a to 10c. By this means, it is possible to smoothly raise the extension portions 10a to 10c without touching each other. Moreover, it is possible to prevent the extension portions 10a to 10c from touching each other, and therefore to dispose the turning members 14a to 14c at the same position in the direction along the watch face 2. Consequently, it is possible to further reduce the size of the opening 12 of the watch face 2. Here, it is preferred that the pointers 3a to 3c are automatically rotated to different positions around the opening 12 of the watch face 2 by pushing a movement switch (not shown). As described above, the pointers 3a to 3c are automatically moved, and therefore it is possible to easily raise the extension portions 10a to 10c.

In this way, the extension portions 10a to 10c are raised to be orthogonal to the upper surface 7 of the watch face 2, that is, raised not to face the upper surface 7. Therefore, it is possible to change the postures of the extension portions 10a to 10c to extend within the opening 12 in the opening direction of the opening 12. By this means, it is possible to smoothly move the watch face 2 along the extension portions 10a to 10c via the opening 12, and therefore to easily remove the watch face 2 from the watch body 1 without removing the pointers 3a to 3c from the watch body 1, as illustrated in FIG. 4B.

Next, as illustrated in FIG. 4C, the extension portions 10a to 10c are inserted into the opening 12 of a new watch face 18, so that it is possible to attach the watch face 18 to the watch body 1. In this way, it is possible to easily replace the watch face 2 with the watch face 18. For example, it is possible to replace the watch face 2 on which the decoration 8 is displayed with the watch face 18 on which a decoration 19 different from the decoration 8 is displayed. Conventionally, it is difficult to remove the watch face 2 from the watch body 1, and therefore it would be necessary to purchase a new watch to change the decoration 8 of the watch face 2. However, with the present embodiment, it is possible to easily change the watch face 2, and therefore to replace the decoration 8 with the decoration 19 only by replacing the watch face 2 with the watch face 18. In addition, the watch face 18 can display various types of the decoration 19, for example, which is designed by the owner or created by an artist. Moreover, the watch face 18 can display the decoration 19 corresponding to a song sung by a singer. For example, the watch face 18 may display the decoration 19 corresponding to the music inputted to an information input unit (not shown) of the watch body 1, or corresponding to the design of a music media such as a CD (compact disk).

In this way, the watch face 18 on which the decoration 19 is displayed is attached to the watch body 1, and then the extension portions 10a to 10c are turned by the turning members 14a to 14c, and returned in the original postures parallel to the watch face 18. At this time, the end portions 16a to 16c abut on the extension portions 10a to 10c in the vicinity of the base ends of the extension portions 10a to 10c, and therefore it is possible to make it easy to return the extension portions 10a to 10c in the original postures. Then, the stop switch (not shown) is released to drive the drive unit 13, so that the rotation of the pointers 3a to 3c is resumed at the right time.

With the present embodiment, the pointers 3a to 3c include the turning members 14a to 14c to change the postures of the extension portions 10a to 10c to be raised. Therefore, it is possible to remove the watch face 2 from the watch body 1 along the extension portions 10a to 10c raised by the turning members 14a to 14c. Accordingly, there is no need to unnecessarily change the shape of the watch face 2 to remove the watch face 2 from the watch body 1. Consequently, it is possible to easily remove the watch face 2 while maintaining the function of the watch face 2 such as the legibility of the time, and the design.

### Embodiment 2

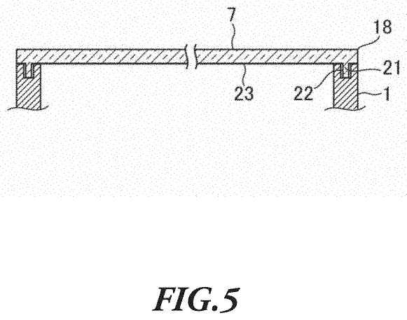

With the above-described Embodiment 1, it is preferred that the watch face 2, 18 has a fixing portion to fix the watch face 2, 18 to the watch body 1. For example, as illustrated in FIG. 5, the watch face 18 according to Embodiment 1 may include fixing portions 21. Meanwhile, concave portions 22 corresponding to the fixing portions 21 are formed in the watch body 1. The two fixing portions 21 are formed to face one another in the vicinity of the edge of the watch face 18 and protrude from a lower surface 23 of the watch face 23.

Here, the fixing portions 21 are provided such that the time displayed on the watch face 18 is located at a predetermined position of the watch body 1 when the fixing portions 21 are fitted in the concave portions 22. Therefore, by fitting the fixing portions 21 in the concave portions 22, it is possible to align the watch face 18 with the watch body 1. With the present embodiment, the watch face 18 includes the fixing portions 21 to fix the watch face 18 to the watch body 1, and therefore it is possible to easily align the watch face 18 with the watch body 1.

### Embodiment 3

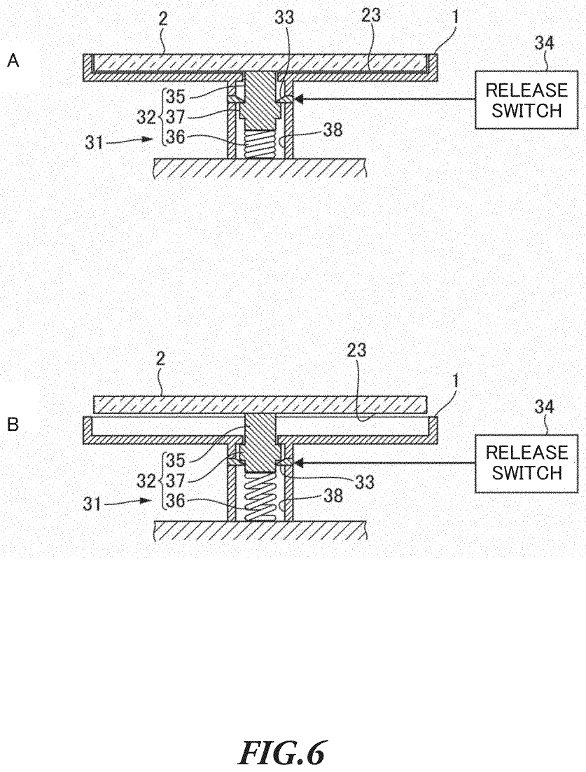

With the above-described Embodiment 1 and 2, it is preferred that the watch body 1 includes an ejector to lift the watch face 2, 18 to separate from the watch body 1. For example, as illustrated in FIG. 6A, the watch body 1 according to Embodiment 1 may include an ejector 31. This ejector 31 includes a lift part 32, a lock part 33 and a release switch 34.

The lift part 32 is configured to lift the watch face 2 in a direction in which the watch face 2 separates from the watch body 1, and includes a lift body 35 and a biasing member 36. The lift body 35 has a pillar shape extending in the watch body 1 in a direction orthogonal to the watch face 2. The front end of the lift body 35 contacts the lower surface 23 of the watch face 2. The lift body 35 includes a protrusion 37 protruding from the side surface of the lift body 35. The lock part 33 engages with the upper surface of the protrusion 37 of the lift body 35 to lock the lift part 32. The lock part 33 protrudes from the side wall of the storage part 38 in which the lift body 35 is stored. In addition, the lock part 33 protruding from the side wall of the storage part 38 can retract into the storage part 38. When the lock part 33 retracts into the storage part 38, it is possible to release the lock on the lift part 32. The release switch 34 is connected to the lock part 33 to allow the lock part 33 to retract into the storage part 38.

In this way, the lift part 32 locked by the lock part 33 is stored in the storage part 38, and therefore does not lift the watch face 2. Accordingly, the watch body 2 remains to be attached to the watch body 1. Then, to remove the watch face 2 from the watch body 1, the release switch 34 is pushed to allow the lock part 33 to retract into the storage part 38. By this means, the lock on the lift body 35 by the lock part 33 is released. Then, as illustrated in FIG. 6B, the lift body 35 biased by the biasing member 36 is raised to separate the watch face 2 from the watch body 1. In this way, the watch face 2 is separated from the watch body 1, and therefore it is possible to smoothly insert the fingers between the watch face 2 and the watch body 1. By this means, it is possible to easily remove the watch face 2 from the watch body 1 along the extension portions 10a to 10c raised by the turning members 14a to 14c. Here, the lock part 33 is biased to protrude from the side wall of the storage part 38, and the protrusion 37 of the lift body 35 is moved from the front of the lock part 33, so that the lock part 33 is moved to protrude from the side wall of the storage part 38.

With the present embodiment, the watch body 1 includes the ejector 31 that lifts the watch face 2 to separate the watch face 2 from the watch body 1, and therefore it is possible to easily remove the watch face 2 from the watch body 1.

### Embodiment 4

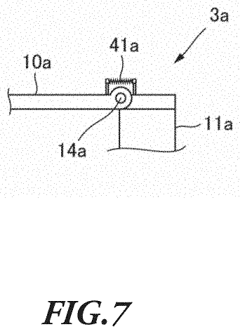

With the above-described Embodiments 1 to 3, it is preferred that the turning members 14a to 14c include assisting parts to bias the extension portions 10a to 10c in the turning direction to assist the extension portions 10a to 10c to change their postures, respectively. For example, as illustrated in FIG. 7, the turning member 14a according to Embodiment 1 may have an assisting part 41a. This assisting part 41a is provided on the upper surface of the extension portion 10a to bias the extension portion 10a to the base end side to assist the extension portion 10a to be raised.

By this means, the extension portion 10a is biased by the assisting part 41a, and therefore it is possible to automatically raise the extension portion 10a by lightly touching the extension portion 10a, and therefore to easily change the posture of the extension portion 10a. Moreover, it is possible to reduce the pressure applied to the extension portion 10a when the extension portion 10a is raised, and therefore to prevent the extension portion 10a from deforming. Here, each of the turning members 14b and 14c includes an assisting part which is the same as that of the turning member 14a.

With the present embodiment, the turning members 14a to 14c include the assisting parts 41a to 41c that bias the extension portions 10a to 10c in the turning direction to assist the extension portions 10a to 10c to change their postures. Therefore, it is possible to easily change the postures of the extension portions 10a to 10c. Moreover, the extension portions 10a to 10c may be automatically turned by the turning members 14a to 14c without touching the extension portions 10a to 10c by the hand.

### Embodiment 5

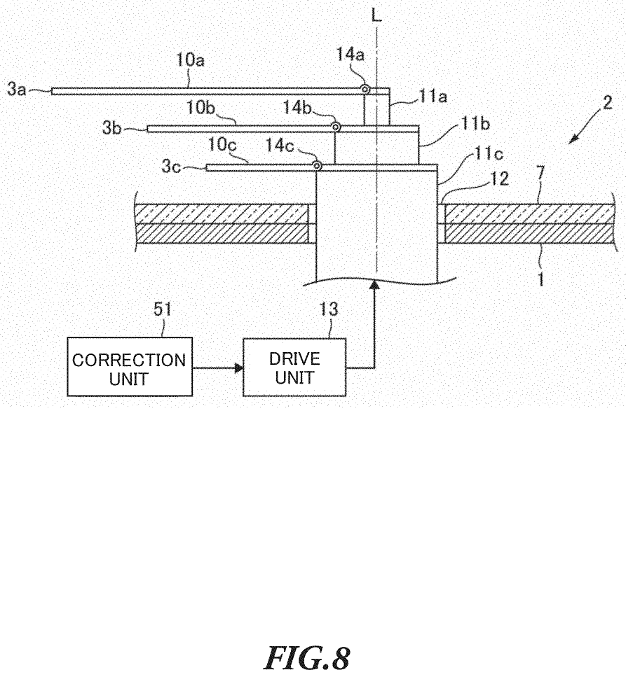

With the above-described Embodiments 1 to 4, it is preferred that the watch body 1 includes a correction unit to correct the differences in the positions of the pointers 3a to 3c. For example, as illustrated in FIG. 8, the watch body 1 according to Embodiment 1 may include a correction unit 51 connected to the drive unit 13. This correction unit 51 includes a receiver that receives a standard time signal transmitted from a standard wave transmitting station. The correction unit 51 calculates the differences in the pointers 31 to 3c from the standard time, based on the standard time received by the receiver and the positions of the pointers 3a to 3c. The calculated differences are outputted from the correction unit 51 to the drive unit 13.

Then, the drive unit 13 corrects the positions of the pointers 3a to 3c, based on the differences inputted from the correction unit 51. By this means, even though the positions of the pointers 3a to 3c are different from the standard time due to, for example, the turning of the extension portions 10a to 10c, the correction unit 51 corrects the differences, and therefore the pointers 3a to 3c can indicate the correct time.

With the present embodiment, the watch body 1 includes the correction unit 51 to correct the differences in the positions of the pointers 31 to 3c, and therefore the pointers 3a to 3c can indicate the correct time.

With the above-described Embodiments 1 to 5, the extension portions 10a to 10c are formed to extend parallel to the upper surface 7 of the watch face 2 from the opening 12 to the edge of the watch face 2. However, the extension portions 10a to 10c may not necessarily extend parallel to the upper surface 7 of the watch face 2 as long as the extension portions 10a to 10c extend to face the upper surface 7 from the opening 12. For example, the extension portions 10a to 10c may be formed to extend at an angle with the upper surface 7 of the watch face 2.

In addition, with the above-described Embodiments 1 to 5, the turning members 14a to 14c turn the extension portions 10a to 10c in the direction approximately orthogonal to the watch face 2. However, this is by no means limiting as long as the turning members 14a to 14c turn the extension portions 10a to 10c to be raised. Moreover, with the above-described Embodiments 1 to 5, the turning members 14a to 14c turn the extension portions 10a to 10c for the same angle with respect to the watch face 2. However, this is by no means limiting as long as the turning members 14a to 14c turn the extension portions 10a to 10c to be raised. For example, the turning members 14a to 14c can change the angle of the turning of the extension portions 10a to 10c depending on the lengths of the extension portions 10a to 10c. That is, the extension portion 10a longer than the extension portion 10b is turned for an angle greater than that of the extension portion 10b. By this means, it is possible to arrange the extension portions 10a to 10c at the same distance from the center of the opening 12 when the extension portions 10a to 10c are raised, and therefore to reduce the size of the opening 12 of the watch face 2.

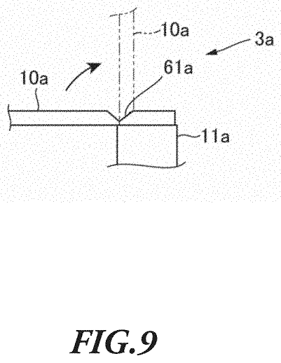

Moreover, with the above-described Embodiments 1 to 5, the turning members 14a to 14c turn the extension portions 10a to 10c to be raised. However, this is by no means limiting as long as it is possible to change the postures of the extension portions 10a to 10c to be raised. For example, as illustrated in FIG. 9, a change portion 61a may be provided instead of the turning member 14a according to Embodiment 1. This change portion 61a is formed as a concave portion on the upper surface of the extension portion 10a to fold the extension portion 10a to be raised in order to change the posture of the extension portion 10a. Here, in order to form this change portion, the extension portions 10a to 10c may be made of a flexible material, and therefore it is possible to fold the extension portions 10a to 10c to be raised, and consequently to change the postures of the extension portions 10a to 10c. In this case, it is preferred that the change portions are made of a shape-memory material.

Moreover, with the above-described Embodiments 1 to 5, the watch face 2, 18 may be made of an elastic material, such as rubber and silicone. Likewise, the time and the decoration displayed on the watch face 2, 18 may be made of an elastic material. By this means, it is possible to deform the opening 12 of the watch face 12, 18. Even when the size of the opening 12 is reduced, it is possible to smoothly move the watch face 2, 18 along the extension portions 10a to 10c. For example, when the turning members 14a to 14c are disposed outside the opening 12 in the direction along the watch face 2, that is, when a circumference formed by the front ends of the extension portions 10a to 10c raised by the turning members 14a to 14c is greater than the opening 12, it is possible to remove the watch face 2 along the extension portions 10a to 10c by deforming the opening 12.

Furthermore, with the above-described Embodiments 1 to 5, it is possible to stereoscopically display the time and the decoration on the watch face 12, 18. For example, the decoration 8 of the watch face 2 may be popped up when the protection member 4 opens. Alternatively, the decoration 8 of the watch face 2 may be formed to move in three dimensions. Furthermore, with the above-described Embodiments 1 to 5, the watch face 2, 18 has a discoid shape. However, this is by no means limiting as long as the watch face 2, 18 has the opening 12.

Furthermore, with the above-described Embodiments 1 to 5, the pointers 3a to 3c are rotated according to the time. However, this is by no means limiting as long as the pointers 3a to 3c extend to face the upper surface 7 of the watch face 2. For example, when the decoration 8 is moved on the watch face 2, the pointers 3a to 3c may be rotated depending on the motion of the decoration 8. Alternatively, the pointers 3a to 3c may be rotated counterclockwise with respect to the time displayed on the watch face 2.

Furthermore, with the above-described Embodiments 1 to 5, the watch has the three pointers 3a to 3c. However, this is by no means limiting, and the watch may have one pointer. Furthermore, with the above-described Embodiments 1 to 5, the watch is a wristwatch. However, this is by no means limiting as long as the pointers 3a to 3c are arranged to sandwich the watch face 2 between the pointers 3a to 3c and the watch body 1. For example, the present invention is applicable to, for example, a wall clock, a table clock, a pocket watch, and an alarm clock.

### REFERENCE SIGNS LIST

1 watch body
2, 18 watch face
3a to 3c pointer
4 protection member
5 display
6 belt
7 upper surface
8, 19 decoration
9 open and close member
10a to 10c extension portion
11a to 11c support portion
12 opening
13 drive unit
14a to 14c turning member
15a turning shaft
16a, 17a end portion
21 fixing portion
22 concave portion
23 lower surface
31 ejector
32 lift part
33 lock part
34 release switch
35 lift body
36 biasing member
37 protrusion
38 storage part
41a assisting part
51 correction unit
61a change portion
L rotation center
Pa to Pc position

1. A watch comprising:
a watch body;
a watch face attached to the watch body and having an opening; and
a pointer including:
an extension portion disposed to sandwich the watch face between the extension portion and the watch body and extending from the opening to face an upper surface of the watch face; and
a support portion protruding from the watch body into the upper surface of the watch face via the opening, and connected directly to the extension portion,
wherein the pointer includes a change portion formed in the extension portion to change a posture of the extension portion such that a front end of the extension portion is raised with respect to a base end of the extension portion to be apart from the watch face, and
the watch face is removed from the watch body along the extension portion raised by the change portion.

2. The watch according to claim 1, wherein the change portion includes a turning member to turn the extension portion to be raised.

3. The watch according to claim 1, wherein the change portion changes the posture of the extension portion to be orthogonal to the watch face.

4. The watch according to claim 1, further comprising:
a plurality of pointers each including the extension portion having the change portion,
wherein the change portion changes postures of extension portions of the plurality of pointers around the opening at different positions.

5. The watch according to claim 1, wherein the watch face includes a fixing portion to fix the watch face to the watch body.

6. The watch according to claim 1, wherein the watch body includes an ejector configured to lift the watch face to separate the watch face from the watch body.

7. A watch face attached to the watch according to claim 1.
